(19) United States
(12) Patent Application Publication
(10) Pub. No.: US 2014/0374403 A1
(43) Pub. Date: Dec. 25, 2014

(54) ELECTRIC HEATER

(71) Applicant: Scott Smith, Silverwater (AU)

(72) Inventor: Scott Smith, Silverwater (AU)

(73) Assignee: Bromic Healing Pty Ltd., Silverwater, NSW (AU)

(21) Appl. No.: 14/342,407

(22) PCT Filed: Aug. 31, 2012
(86) PCT No.: PCT/AU2012/001020

§ 371 Date: Jul. 15, 2014

(30) Foreign Application Priority Data
Sep. 2, 2011 (AU) 2011903572

(51) Int. Cl. F24H 3/00; G01J 5/00; F24C 15/22

(52) U.S. Cl. CPC F24H 3/002; F24C 15/22; G01J 5/0044
USPC 219/522; 374/121

(57) ABSTRACT

An electric heater (10) includes at least one heater element (12) which is adapted to emit electromagnetic radiation (30) having a first wavelength. A reflector (16) adjacent the heater element reflects radiation from the element, the reflected radiation (32) also having the first wavelength. A portion of the emitted and reflected radiation intersects a heater cover (26), which re-emits that radiation such that the re-emitted radiation (36) has a second wavelength different to the first wavelength. The cover has a plurality of apertures (28) which allow passage of another portion of the incident electromagnetic radiation through the cover, that portion having the first wavelength.

### Field of the Invention

The present invention relates to an electric heater.

### BACKGROUND OF THE INVENTION

Electric heaters are popular in indoor and outdoor environments because they are easy to operate and, unlike other heaters, usually do not emit significant fumes or emissions which can be detrimental to those in the vicinities of the heaters.

Where rapid heating is required, such as in outdoor settings where the temperature has dropped, quartz element heaters may be suitable. A disadvantage of conventional quartz element heaters is that they tend to produce relatively small areas of concentrated heat in close proximity to the heaters. The intensity of the heat often gives rise to discomfort to people close to the heaters. In addition, the heat and glare produced by such quartz elements is often harsh on the skin and eyes of people near the heaters.

Outdoor heaters exist which use quartz elements as heat sources but which direct the heat using parabolic reflectors positioned behind the quartz elements. While this reduces the heating effect on the rear sides of the reflectors, the shape of the parabolic reflectors also creates relatively small and concentrated zones of heat in the areas directly in front of the heaters which can still negatively affect people who are close to the heaters.

In addition, the effectiveness of these heaters is usually limited to an area in relatively close proximity to the heaters and within a narrow angular field.

Therefore it would be desirable to provide an electric heater which ameliorates one or more of the disadvantages of the above prior art, or which provides a useful alternative thereto.

Any reference herein to the prior art does not constitute, and is not to be taken as, an admission or suggestion that the prior art was known to any particular person or group or class of people, or that it was part of the common general knowledge anywhere as at the priority date of any of the claims of this document.

### SUMMARY OF THE INVENTION

According to a first aspect of the invention there is provided an electric heater including:
an electrical connector for connection to an electric current supply;
a heater element adapted for electrical connection to the connector so as to be energised by electric current from a said current supply when the supply is connected to the electrical connector, and when so energised, to emit electromagnetic radiation having a first wavelength;
at least one reflector adjacent to the heater element and adapted to reflect electromagnetic radiation emitted from the element so as to direct such reflected electromagnetic radiation in at least one heating direction; and
a cover adjacent to the heater element, the cover having a first side and a second side opposite to the first side,
wherein the cover is positioned such that the heater element is disposed between said first side and the at least one reflector, and for the first side to be intersected by at least part of the incident electromagnetic radiation emanating directly from the heater element and incident electromagnetic radiation reflected by the reflector in said at least one heating direction, the cover being adapted to re-emit a first portion of such incident electromagnetic radiation from said second side such that the re-emitted electromagnetic radiation has a second wavelength different to said first wavelength.

In a preferred embodiment, said first portion is in the range from 1% to 40% of a total of the incident electromagnetic radiation. Preferably, said first portion is in the range from 15% to 25% of a total of the incident electromagnetic radiation. More preferably, said first portion is substantially 20% of a total of the incident electromagnetic radiation.

In a preferred embodiment, the first wavelength is in the range of 0.8 microns to 5.5 microns. Also according to a preferred embodiment, the first wavelength is substantially 4.3 microns.

In a preferred embodiment, the second wavelength is greater than the first wavelength.

In a preferred embodiment, the second wavelength is in the range from 1.3 microns to 9.0 microns. Preferably, the second wavelength is in the range from 5.5 microns to 7.0 microns. More preferably, the second wavelength is substantially 6.1 microns.

In a preferred embodiment, the cover defines a plurality of apertures each opening through the first side and the second side of the cover, and adapted for allowing passage of a second portion of the incident electromagnetic radiation through the cover.

Preferably, the cover extends over a total cover area, and the apertures constitute a part of said total area, said part being in the range of 60% to 99% of the total cover area.

More preferably, said part of the total area is in the range of 75% to 85% of the total cover area.

Even more preferably, said part is substantially 80% of the total cover area.

In a preferred embodiment, the shape of the apertures is selected from at least one of round, oval, triangular, hexagonal and square shapes.

In a preferred embodiment, the cover is substantially of a metal having a conductivity and emissivity that enables the cover to withstand temperatures in the range from 400° C. to 800° C.

In a preferred embodiment, the electric heater includes a housing accommodating said reflector and said heater element, the housing defining an open front, wherein the cover extends over the open front.

In a preferred embodiment, the heater element includes at least one of an electrically heated filament, a metal sheathed type element, a quartz type heating element, and a halogen gas heated lamp.

In a preferred embodiment, the reflector is elongate and has a reflective surface which is at least one of substantially parabolic and substantially flat in cross section along its length.

In a preferred embodiment, the cover is elongate and is at least one of substantially parabolic and substantially flat in cross section along its length.

According to a second aspect of the invention there is provided a method of determining heating performance characteristics of an electric heater, the method including the following steps:
A. providing an electric heater which includes an electrical connector for connection to an electric current supply; a heater element adapted for electrical connection to the connector so as to be energised by electric current from a said current supply when the supply is connected to the electrical connector, and when so energised, to emit electromagnetic radiation having a first wavelength; at least one reflector adjacent to the heater element and adapted to reflect electromagnetic radiation emitted from the element so as to direct such reflected electromagnetic radiation in at least one heating direction; and a cover adjacent to the heater element, the cover having a first side and a second side opposite to the first side, wherein the cover is positioned such that the heater element is disposed between said first side and the at least one reflector, and for the first side to be intersected by at least part of the incident electromagnetic radiation emanating directly from the heater element and incident electromagnetic radiation reflected by the reflector in said at least one heating direction, the cover being adapted to re-emit a first portion of such incident electromagnetic radiation from said second side such that the re-emitted electromagnetic radiation has a second wavelength different to said first wavelength, the cover defining a plurality of apertures each opening through the first side and the second side of the cover, and adapted for allowing passage of a second portion of the incident electromagnetic radiation through the cover;
B. determining desired heating characteristics of the heater; and
C determining the proportion of a total area of the cover which is constituted by said apertures, in order to achieve said desired heating characteristics.

In a preferred embodiment, step C includes determining the proportion of the total cover area which is constituted by said apertures to be in the range of 60% to 99% of the total cover area.

Preferably, step C includes determining the proportion of the total cover area which is constituted by said apertures to be in the range of 75% to 85% of the total cover area.

More preferably, step C includes determining the proportion of the total cover area which is constituted by said apertures to be substantially 80% of the total cover area.

In a preferred embodiment, in step A, the apertures are selected from at least one of round, oval, triangular, hexagonal and square shapes.

### BRIEF DESCRIPTION OF THE DRAWINGS

Preferred embodiments of the invention will now be described, by way of example only, with reference to the accompanying drawing, in which:

FIG. 1 is an exploded perspective view of an electric heater according to an embodiment of the invention;

FIG. 2a is a front view of the heater of FIG. 1;

FIG. 2b is a perspective view of the heater of FIG. 1;

FIG. 2c is a longitudinal section view along the heater of FIG. 1;

FIG. 2d is a front view of an electric heater according to a further embodiment of the invention;

FIG. 2e is a front view of an electric heater according to a further embodiment of the invention;

FIG. 2f is a front view of an electric heater according to a further embodiment of the invention;

FIG. 2g is a schematic right hand end view of the heater of FIG. 1;

FIG. 3a is a front view of an electric heater according to another embodiment of the invention;

FIG. 3b is a perspective view of the heater of FIG. 3a;

FIG. 3c is a longitudinal section view along the heater of FIG. 3a;

FIG. 3d is a front view of an electric heater according to another embodiment of the invention;

FIG. 3e is a front view of an electric heater according to a further embodiment of the invention; and

FIG. 3f is a front view of an electric heater according to a further embodiment of the invention.

### DETAILED DESCRIPTION OF PREFERRED EMBODIMENTS

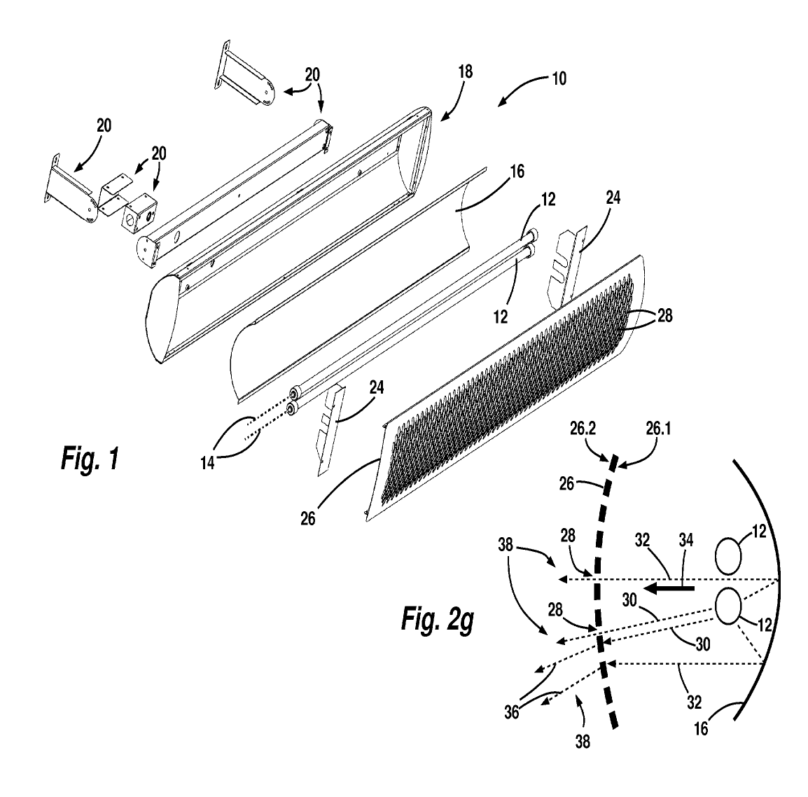

Referring to the drawings, the electric heater 10 illustrated in FIG. 1 includes elongate, tubular quartz heater elements 12. The heater 10 includes an electrical connector 14 (shown schematically in phantom lines) adapted for connection to a power supply (not shown).

The heater elements 12 are electrically connected to the electrical connector 14 so as to be powered, and hence to receive a source of electrical current, when the electrical connector is connected to the power supply.

While two heater elements 12 are shown, it will be appreciated that any suitable number of heater elements could be used instead, ranging from one, to more than two. In addition, while the heater elements 12 are quartz elements, other suitable types of elements may be used instead. For example, the elements may include electrically heated filaments, metal sheathed type elements, quartz type heating elements or heated lamps that use halogen gas.

Adjacent to the heat emitting elements 12 is a reflector 16. The reflector 16 is elongate, and substantially parabolic in cross-section along its length.

The heat emitting elements 12 and reflector 16 are positioned within a housing 18. There are provided various brackets 20 which are for removably mounting the electric heater 10, for example on a wall or to a ceiling (not shown).

The heater elements 12 are secured in place in relation to the housing 18 by way of element brackets 24.

A cover 26 is provided which is placed over the housing 18 and which thus covers the heater elements 12 and the reflector 16. The cover 26 has a first surface 26.1 and an opposite second surface 26.2, with the heater elements 12 being disposed between the first surface and the reflector 16.

The cover 26 has apertures 28 which extend though the cover so as to open out through the first surface 26.1 and second surface 26.2.

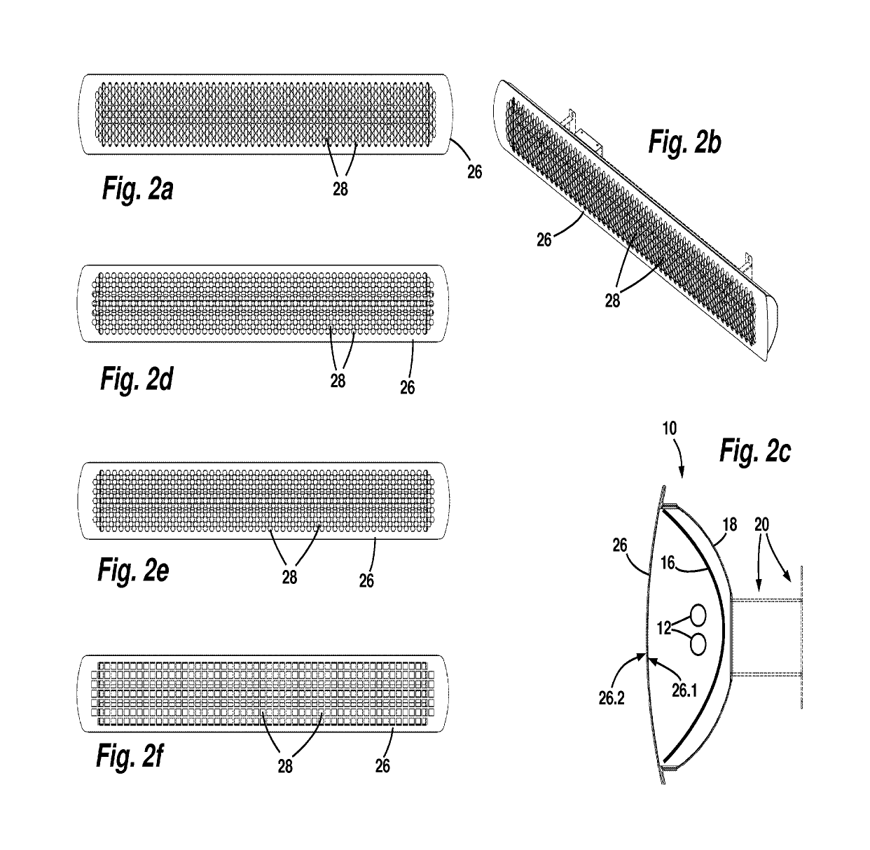

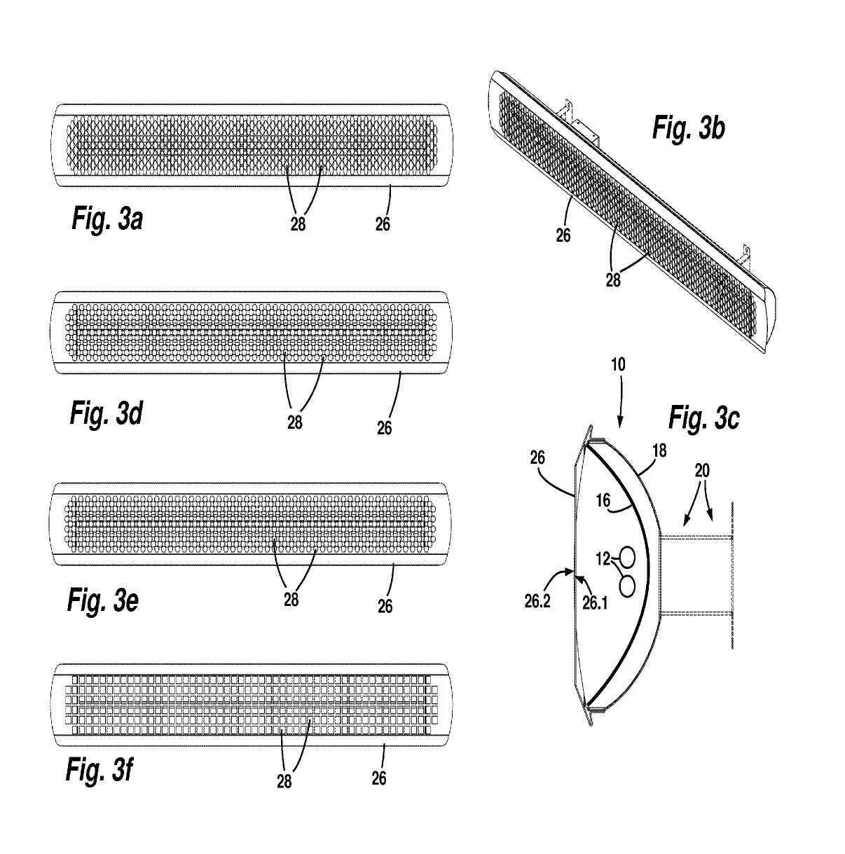

As described in more detail with reference to FIGS. 2a to 3f, the cover 26 may be made from a number of different suitable materials.

As shown, the cover 26 is elongate, and may be substantially flat or parabolic in cross-section viewed along the length of the cover.

As further discussed below, the apertures 28 in the cover 26 may be of a number of shapes including oval, circular, hexagonal, triangular, and square.

In operation, the electrical connector 14 is connected to a power supply (not shown) which provides current to the heater elements 12 for heating the elements.

As the heater elements 12 become heated, they emit electromagnetic radiation 30 (referred to below as emitted radiation), having a first wavelength. The emitted radiation 30 is emitted in all directions, but in particular radially outwards from the heater elements 12.

Most of the emitted radiation 30 is emitted from the heater elements 12 towards the cover 26, and towards the reflector 16.

The emitted radiation 30 that is emitted towards the cover 26 constitutes incident electromagnetic radiation intersecting the area spanned by cover.

The emitted radiation 30 which is directed towards the reflector 16 is reflected as reflected electromagnetic radiation 32, essentially having the same wavelength as that of the emitted radiation 30 (i.e. the first radiation).

The reflector 16 directs the reflected radiation 32 in a heating direction indicated by the arrow 34, as a result of the parabolic shape of the reflector. Thus, the reflected radiation 32 is directed past the heater elements 12 towards the cover 26, where it also constitutes incident electromagnetic radiation intersecting the area spanned by the cover.

If the incident electromagnetic radiation intersects with the area spanned by the cover 26 at a position where an aperture 28 is located, this incident electromagnetic radiation can simply pass through the aperture while the other incident electromagnetic radiation that does not pass through the apertures is absorbed into the material of the cover.

As mentioned above, the emitted radiation 30 emanating from the heater elements 12 and the reflected radiation 32 from the reflector 16 each have a first wavelength.

According to one preferred embodiment, this first wavelength is within the range from 0.8 microns to 5.5 microns, and in one specific form of this embodiment, substantially 4.3 microns. Typically, the wavelength of such electromagnetic radiation is a function of the temperature of the source of that radiation (e.g. the elements 12). The wavelength range of 0.8 microns to 5.5 microns corresponds to a heat source temperature in the range from about 300° C. to 900 ° C. A wavelength of approximately 4.3 microns corresponds to a temperature of around 400° C. to 500° C. of the heating elements 12.

The portion of the incident electromagnetic radiation 30, 32 passing through the apertures 28 remains essentially unaltered by the cover 26, so that the wavelength of the radiation as it passes through the cover remains at 4.3 microns according to the particular embodiment mentioned above.

However, the incident electromagnetic radiation 30, 32 that does not pass through the apertures 28 is essentially re-emitted by the cover 26 as re-emitted radiation 36.

The material of the cover 26 and the process of absorbing and re-emitting of the incident electromagnetic radiation 30, 32 by the cover, results in the re-emitted radiation 36 being of a second wavelength which is different to the first wavelength of the incident radiation. The cover 26 is preferably of a dark colour, which is preferably black. While other colours will suffice for re-emitting of the incident electromagnetic radiation 30, 32 and therefore can be used, the dark or black colour should assist in attaining a greater level of efficiency in the re-emission.

This second wavelength, according to a preferred embodiment, is in the range of 1.3 microns to 9.0 microns. According to one, more specific form of this embodiment, the second wavelength is in the range of 5.5 microns to 7.0 microns. According to one, even more specific form of this embodiment, the second wavelength is substantially 6.1 microns.

The range of wavelengths of 1.3 microns to 9.0 microns corresponds to a temperature of the heat source (e.g. the cover 26) of around 50° C. to 450° C., while the wavelength of 6.1 microns corresponds to a temperature of around 150° C. to 200° C. of the source of that radiation.

In other embodiments, the first and second wavelengths may be different to those specific values mentioned above. Indeed, one of the factors that may affect the wavelength of the incident radiation 30, 32 and the re-emitted radiation 36 is the nature and construction of the heater elements 12. While the specific values of the first and second wavelengths may differ, an important feature of the invention is that in each particular embodiment, the first and second wavelengths are different to each other, with the second wavelength preferably being greater than the first wavelength.

Another important feature determining the wavelengths for which the heater 10 is designed, is the desired operational range of temperatures for the heater. A larger wattage heater intended for greater heating effect is provided with more powerful elements which can produce greater heat than less powerful elements, and as the wavelength is typically a function of the temperature of the heat source, this greater heat will result in shorter wavelengths. The converse also applies.

The electromagnetic radiation emanating from the second side 26.2 of the cover 26 is essentially constituted by that part of the incident radiation 30, 32 which passes through the apertures 28, and the re-emitted radiation 36. This combination is referred to below collectively as the heater radiation, which is generally referenced as 38.

It will be appreciated that the proportion of heater radiation 38 which is of the first wavelength, and the proportion of heater radiation that is of the second wavelength, can be determined by the proportion of the overall area of the cover 26 that is constituted by apertures 28. The greater the area constituted by the apertures 28 in relation to the overall area of the cover 26, the more incident electromagnet radiation 30, 32 will be allowed to pass through the cover without the wavelength of that radiation, i.e. the first wavelength, being affected by the cover. Similarly, this will also result in a smaller percentage of the incident electromagnetic radiation 30, 32 striking the cover 26 and thus being absorbed and re-emitted by the cover as the re-emitted radiation 32 at the second wavelength.

Indeed, the percentage of the area of the cover 26 which is constituted by the apertures 28 is in proportion to the amount of electromagnetic radiation having the first wavelength emanating as part of the heater radiation 38 from the cover 26, relative to the heater radiation as a whole.

For example, a given percentage increase in the overall area of the cover 26 which is constituted by the apertures 28 will, according to the preferred embodiment, result in a similar percentage increase in the amount of electromagnetic radiation having the first wavelength emanating from the cover 26 relative to the heater radiation 38 as a whole.

It has been found that, according to preferred embodiments, desirable heating effects of the electric heater 10 are achieved when 75% to 85% of the overall area of the cover 26 is constituted by apertures 28.

Indeed, according to one preferred embodiment, the proportion of incident electromagnetic radiation 30, 32 that is allowed to pass through the apertures 28, and hence retain its first wavelength, is in the range of about 75% to 85%, preferably 80%, while the proportion of incident electromagnetic radiation that does not pass through the apertures, and which is effectively absorbed by the cover 26 and re-emitted as re-emitted radiation 36 having the second wavelength, is in the range of about 15% to 25%, preferably 20%.

The re-emitted radiation 36 having the longer, second wavelength (e.g. 6.1 microns), and hence being of a lower frequency, has been found to create a less intense heat close to the cover 26, than the shorter, first wavelength (e.g. 4.3 microns). This is where people are likely to be positioned to be heated by the heater 10.

Conversely, the re-emitted radiation 36 having the longer, second wavelength has been found to have a greater heating effect at a distance from the heater 10 than the radiation with the shorter, first wavelength.

In light of the above, it will be appreciated that when the heater 10 (or a heater of that type) is being designed, the total area of the cover 26 which is constituted by the apertures 28 can be determined with a view to achieving desirable heating characteristics of the heater.

The area that can be effectively heated by the electric heater 10 is not only affected by the proportion of the overall area of the cover 26 that is constituted by the apertures 28, but also by the shape of the cover. While many different shapes may be suitable as would be understood by those skilled in the art, it has been found that a cover 26 of substantially flat or parabolic shape facilitates desirable reflection and refraction of energy.

While the parabolic cross-sectional shape of the reflector 16 can result in electromagnetic radiation being reflected in the direction of the arrow 34, towards the cover 26, in a preferred embodiment the cover, as a result of its shape, effectively disperses the electromagnetic radiation by re-emitting a portion of the incident radiation as re-emitted radiation 38 at a wider angle to that of the incident radiation, for example 120 degrees, thereby providing heat across a greater area than that which would be heated if the angle were limited to that of the incident radiation.

As a result of the combination of the wavelengths of the incident radiation (made up of the emitted radiation 30 and reflected radiation 32) and the features of the cover 26, a greater overall length and width of area of effective heating by the electric heater 10 may be achieved, at least in preferred embodiments, than might be achieved in the absence of such features.

In addition, the cover 26, by allowing only a portion of the incident electromagnetic radiation 30, 32 with the shorter wavelength to pass directly from the heater elements 12 and reflector 16 through the apertures 28, assists in reducing the intensity of the heating effect in a heated zone directly in front of the heater 10.

As explained above, according to a preferred embodiment, the remaining portion of the incident electromagnetic radiation 30, 32 which is absorbed by the cover 26 is not lost, but is effectively re-emitted from the cover as the re-emitted radiation 36 having the longer wavelength, at a wider angle than the incident radiation, and this results in a wider and longer heated area.

A substantially even distribution of apertures 28 across the cover 26 can assist in providing an even heating effect by the electric heater 10.

In addition, the presence of the cover 26, with only a portion thereof constituted by aperture 28, assists in reducing the effects of glare from the heater elements 12 on a person positioned near to the electric heater 10.

Referring to FIGS. 2a to 2f, there are shown representations of electric heaters 10 and covers 26 according to other embodiments.

In FIGS. 2a to 2f, there are shown embodiments of covers 26 which are curved so as to be substantially parabolic in profile.

In the embodiment of FIGS. 2a, 2b and 2c, the apertures 28 are oval or elliptical.

In the embodiment of FIG. 2d, the apertures 28 are circular.

In the embodiment of FIG. 2e, the apertures 28 are hexagonal.

In the embodiment of FIG. 2f, the apertures 50 are square.

In FIGS. 3a to 3f, there are shown embodiments of covers 26 which are flat in profile.

In the embodiment of FIGS. 3a, 3b and 3c, the apertures 28 are oval or elliptical.

In the embodiment of FIG. 3d, the apertures 28 are circular.

In the embodiment of FIG. 3e, the apertures 28 are hexagonal.

In the embodiment of FIG. 3f, the apertures 28 are square.

Although the invention is described above in relation to preferred embodiments, it will be appreciated by those skilled in the art that it is not limited to those embodiments, but may be embodied in many other forms.

1. An electric heater including:
an electrical connector for connection to an electric current supply;
a heater element adapted for electrical connection to the connector so as to be energised by electric current from a said current supply when the supply is connected to the electrical connector, and when so energised, to emit electromagnetic radiation having a first wavelength;
at least one reflector adjacent to the heater element and adapted to reflect electromagnetic radiation emitted from the element so as to direct such reflected electromagnetic radiation in at least one heating direction; and
a cover adjacent to the heater element, the cover having a first side and a second side opposite to the first side,
wherein the cover is positioned such that the heater element is disposed between said first side and the at least one reflector, and for the first side to be intersected by at least part of the incident electromagnetic radiation emanating directly from the heater element and incident electromagnetic radiation reflected by the reflector in said at least one heating direction, the cover being adapted to re-emit a first portion of such incident electromagnetic radiation from said second side such that the re-emitted electromagnetic radiation has a second wavelength different to said first wavelength.

2. The electric heater of claim 1, wherein said first portion is in the range from 1% to 40% of a total of the incident electromagnetic radiation.

3. The electric heater of claim 2, wherein said first portion is in the range from 15% to 25% of a total of the incident electromagnetic radiation.

4. The electric heater of claim 1, wherein said first portion is substantially 20% of a total of the incident electromagnetic radiation.

5. The electric heater of claim 1, wherein the first wavelength is in the range from 0.8 microns to 5.5 microns.

6. The electric heater of claim 5, wherein the first wavelength is substantially 4.3 microns.

7. The electric heater of claim 1, wherein the second wavelength is greater than the first wavelength.

8. The electric heater of claim 1, wherein the second wavelength is in the range from 1.3 microns to 9.0 microns.

9. The electric heater of claim 8, wherein the second wavelength is in the range from 5.5 microns to 7.0 microns.

10. The electric heater of claim 9, wherein the second wavelength is substantially 6.1 microns.

11. The electric heater of claim 1, wherein the cover defines a plurality of apertures each opening through the first side and the second side of the cover, and adapted for allowing passage of a second portion of the incident electromagnetic radiation through the cover.

12. The electric heater of claim 11, wherein the cover extends over a total cover area, and wherein the apertures constitute a part of said total area, said part of the total area being in the range of 60% to 99% of the total cover area.

13. The electric heater of claim 12, wherein said part of the total area is in the range of 75% to 85% of the total cover area.

14. The electric heater of claim 13, wherein said part of the total area is substantially 80% of the total cover area.

15. The electric heater of claim 11, wherein the shape of the apertures is selected from at least one of round, oval, triangular, hexagonal and square shapes.

16. The electric heater of claim 1, wherein the cover is substantially of a metal having a conductivity and emissivity that enables the cover to withstand temperatures in the range from 400° C. to 800° C.

17. The electric heater of claim 1, including a housing accommodating said reflector and said heater element, the housing defining an open front, wherein the cover extends over the open front.

18. The electric heater of claim 1, wherein the heater element includes at least one of an electrically heated filament, a metal sheathed type element, a quartz type heating element, and a halogen gas heated lamp.

19. The electric heater of claim 1, wherein the reflector is elongate and has a reflective surface which is at least one of substantially parabolic and substantially flat in cross section along its length.

20. The electric heater of claim 1, wherein the cover is elongate and is at least one of substantially parabolic and substantially flat in cross section along its length.

21. A method of determining heating performance characteristics of an electric heater, the method including the following steps:
21.1 providing an electric heater which includes an electrical connector for connection to an electric current supply; a heater element adapted for electrical connection to the connector so as to be energised by electric current from a said current supply when the supply is connected to the electrical connector, and when so energised, to emit electromagnetic radiation having a first wavelength; at least one reflector adjacent to the heater element and adapted to reflect electromagnetic radiation emitted from the element so as to direct such reflected electromagnetic radiation in at least one heating direction; and a cover adjacent to the heater element, the cover having a first side and a second side opposite to the first side, wherein the cover is positioned such that the heater element is disposed between said first side and the at least one reflector, and for the first side to be intersected by at least part of the incident electromagnetic radiation emanating directly from the heater element and incident electromagnetic radiation reflected by the reflector in said at least one heating direction, the cover being adapted to re-emit a first portion of such incident electromagnetic radiation from said second side such that the re-emitted electromagnetic radiation has a second wavelength different to said first wavelength, the cover defining a plurality of apertures each opening through the first side and the second side of the cover, and adapted for allowing passage of a second portion of the incident electromagnetic radiation through the cover;
21.2 determining desired heating characteristics of the heater; and
21.3 determining the proportion of a total area of the cover which is constituted by said apertures, in order to achieve said desired heating characteristics.

22. The method of claim 21 wherein step 21.3 includes determining the proportion of the total cover area which is constituted by said apertures to be in the range of 60% to 99% of the total cover area.

23. The method of claim 21 wherein step 21.3 includes determining the proportion of the total cover area which is constituted by said apertures to be in the range of 75% to 85% of the total cover area.

24. The method of claim 21 wherein step 20.3 includes determining the proportion of the total cover area which is constituted by said apertures to be substantially 80% of the total cover area.

25. The method of claim 21, wherein, in step 21.1, the apertures are selected from at least one of round, oval, triangular, hexagonal and square shapes.
